(19) United States
(12) Patent Application Publication
(10) Pub. No.: US 2023/0412762 A1
(43) Pub. Date: Dec. 21, 2023

(54) SYSTEMS AND METHODS FOR VIDEO CONFERENCING

(71) Applicant: MORE THAN A FAN, INC., Kew Gardens, NY (US)

(72) Inventors: Zachary John GOLDSTEIN, Kew Gardens, NY (US); John Michael SWARTZ, Kew Gardens, NY (US); Vladic Vladimir RAVICH, Kew Gardens, NY (US); Salimah Yvette EBRAHIM, Kew Gardens, NY (US); Brian Wendell REDFERN, Kew Gardens, NY (US)

(21) Appl. No.: 18/032,684

(22) PCT Filed: Oct. 19, 2021
(86) PCT No.: PCT/US2021/055615

§ 371 Date: Apr. 19, 2023

Related U.S. Application Data
(60) Provisional application No. 63/093,638, filed on Oct. 19, 2020.

(51) Int. Cl. H04N 7/15; H04N 7/14

(52) U.S. Cl. CPC H04N 7/15; H04N 7/147

(57) ABSTRACT

An example method of video conferencing includes: receiving, from a control sewer, an initiation package for a client account associated with a client device, the initiation package including a client participant identifier defining the client account within a video conferencing session, a base map, and a position of the client account on the base map; displaying, at the client device, the base map and a position marker on the base map, the position marker representing the position of the client account on the base map; obtaining a set of nearby participant identifiers representing nearby participant accounts selected based on a proximity of respective positions of the nearby participant accounts to the position of the client account; obtaining, based on the set of nearby participant identifiers, a set of media streams for the nearby participant accounts; and outputting the set of media streams at the client device.

### FIELD

The specification relates generally to communications systems, and more particularly to systems and methods for video conferencing.

### BACKGROUND

Video conferencing allows users at different locations to exchange media streams, including audio and video streams to communicate with one another, in an imitation of an in-person meeting. Video conferencing software may additionally allow communication with multiple users within a room.

### SUMMARY

According to an aspect of the present disclosure, a method of video conferencing is provided. The method includes: receiving, from a control server, an initiation package for a client account associated with a client device, the initiation package including a client participant identifier defining the client account within a video conferencing session, a base map, and a position of the client account on the base map; displaying, at the client device, the base map and a position marker on the base map, the position marker representing the position of the client account on the base map; obtaining a set of nearby participant identifiers representing nearby participant accounts selected based on a proximity of respective positions of the nearby participant accounts to the position of the client account; obtaining, based on the set of nearby participant identifiers, a set of media streams for the nearby participant accounts; and outputting the set of media streams at the client device.

### BRIEF DESCRIPTION OF DRAWINGS

Implementations are described with reference to the following figures, in which:

FIG. 1 depicts a schematic diagram of an example video conferencing system;

FIG. 2 depicts a block diagram of certain internal components of a control server and a client device in the system of FIG. 1;

FIG. 3 depicts a flowchart of an example method of video conferencing;

FIG. 4 depicts a schematic diagram of an example video conferencing session;

FIG. 5A depicts a schematic diagram of an example media exchange system in the system of FIG. 1;

FIG. 5B depicts a flowchart of an example method of exchanging media in the system of FIG. 5A;

FIG. 6A depicts a schematic diagram of another example media exchange system in the system of FIG. 1;

FIG. 6B depicts a flowchart of an example method of exchanging media in the system of FIG. 6A;

FIG. 7 depicts a flowchart of an example method of broadcasting;

FIG. 8A depicts a flowchart of an example method of navigating a map;

FIG. 8B depicts a flowchart of an example method of updating media streams;

FIG. 9 depicts a flowchart of an example method of joining a group;

FIG. 10 depicts a flowchart of an example method of navigating a map while in a group;

FIG. 11 depicts a flowchart of an example method of leaving a group;

FIG. 12 depicts a schematic diagram of yet another media exchange system in the system of FIG. 1;

FIG. 13A depicts a flowchart of an example method of allocating a server;

FIG. 13B depicts a flowchart of an example method of connecting to a region; and

FIG. 13C depicts a flowchart of an example method of disconnecting from a region.

### DETAILED DESCRIPTION

Existing video conferencing software allow users at different locations to exchange media streams including audio and video data. Generally, participants within the same video conferencing session exchange media streams with each of the other participants. This can lead to difficulty having intimate discussions, as only one user may speak at a time, which may lead to lower engagement. Some solutions provide breakout room capability as provisioned by a moderator of the video conferencing session, while other solutions provide smaller defined tables which users may join to exchange media sessions with the other participants in the room or at the table. However, such solutions provide only discrete rooms or tables and do not allow users to more freely and naturally navigate around the video conferencing session.

Accordingly, an example system provides a video conferencing session with natural and continuous navigation around a space to allow participants to approach and move away from other participants, as well as different regions in the session. Each participant may exchange media streams with nearby participants, selected, for example based on a k-nearest neighbors' classification. Further, the media streams may be weighted by distance, so that media streams of closer participants appear with greater strength (e.g., opacity and volume) than participants further away on the map. As participants move around the map, the weighting may fade the media streams in and out accordingly, to enable a natural effect of moving towards and away from other participants.

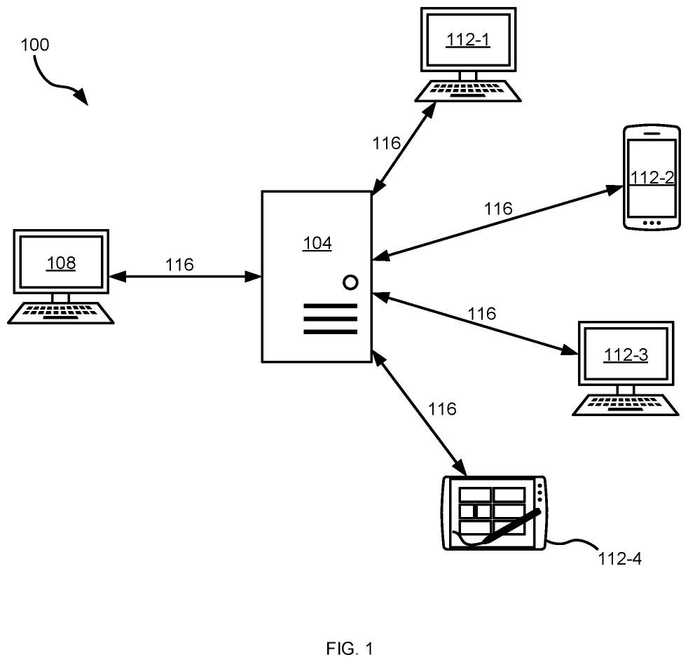

FIG. 1 depicts an example system 100 for video conferencing. The system 100 includes a control server 104 configured to manage video conference sessions between a client device 108 and a plurality of further participant devices, of which four example participant devices 112-1, 112-2, 112-3, 112-4 (referred to generically as a participant device 112 and collectively as the participant devices 112) are depicted. In particular, the system 100 allows for a dynamic video conferencing session, wherein the media streams experienced by any one participant is based on the relative positions of the other participants. Further, the system 100 provides a continuously navigable video conferencing session, in which users may navigate on a continuous map, rather than being restricted to assigned or discrete rooms or regions.

The control server 104 is generally configured to manage the video conference sessions, including defining the sessions, participants in the sessions, and to provide each of the client device 108 and the participant devices 112 with relevant information in order to obtain the appropriate media streams for conferencing with other participants in the video conferencing session. In particular, the control server 104 manages the position data of each of the participants and provides the position data to the client device 108 and the participant devices 112 to enable the dynamic video conferencing. The internal components and the functionality of the control server 104 will be described in further detail below. As will be appreciated, in some examples, the functionality of the control server 104 may be implemented on any suitable server environment, including a plurality of cooperating servers, a cloud-based server environment, or the like.

The client device 108 is a computing device, such as a personal computer, a laptop, a tablet, a mobile device, or the like. The internal components and the functionality of the client device 108 will be described in further detail below. The further participant devices 112 are also computing devices such as personal computers, laptops, tablets, kiosks, mobile devices, or the like. The client device 108 may be operated by a user wishing to participate in a video conferencing session with the users of the other participant devices 112.

The client device 108 and the participant devices 112 are in communication with the control server 104 via communications links 116. The communications links 116 may be wired or wireless or a combination of wired and wireless communication links. For example, the communication links may be provided by a wireless local area network (WLAN) deployed by one or more access points (not shown). In other examples, the communication links 116 may include one or more wide-area networks such as the Internet, mobile networks, combinations of the above, and the like. The client device 108 and the participant devices 112 may also, in some examples, be in direct communication with one another and/or with other communications servers, as will be described in further detail below.

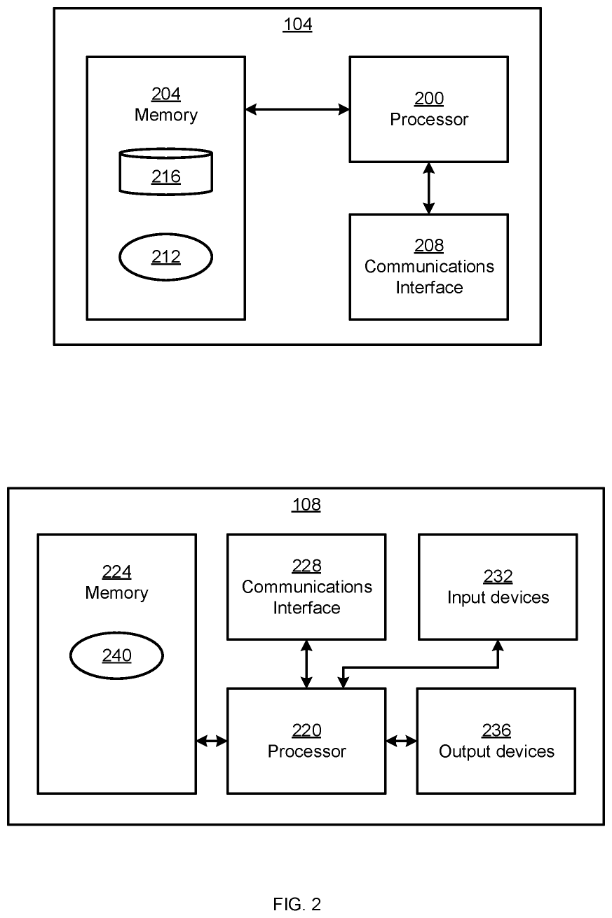

Referring now to FIG. 2, a block diagram of certain internal components of the control server 104 and the client device 108 is depicted.

The control server 104 includes a processor 200 interconnected with a non-transitory computer-readable storage medium, such as a memory 204, and a communications interface 208.

The processor 200 may include a central processing unit (CPU), a microcontroller, a microprocessor, a processing core, a field-programmable gate array (FPGA) or similar. The processor 200 may include multiple cooperating processors. The processor 200 may cooperate with the memory 204 to realize the functionality discussed herein.

The memory 204 may include a combination of volatile (e.g. Random Access Memory or RAM) and non-volatile memory (e.g. read only memory or ROM, Electrically Erasable Programmable Read Only Memory or EEPROM, flash memory). All or some of the memory 204 may be integrated with the processor 200. The memory 204 stores applications, each including a plurality of computer-readable instructions executable by the processor 200. The execution of the instructions by the processor 200 configures the control server 104 to perform the actions discussed herein. In particular, the applications stored in the memory 204 include a participant management application 212 to a video conferencing session and the participants of the video conferencing session, including providing position data to the participants to enable dynamic and position-based video conferencing.

The memory 204 also stores a session database 216 storing data for various video conferencing sessions. In particular, the session database 216 may include a session definition, including a session identifier, a base map associated with the session, and the like. In particular, the base map may define a map area in which users are placed, and through which users may navigate. More particularly, the map area is a continuously navigable space, rather than having discrete positioning for users to be placed. The base map may further include various regions within the map defining certain communications behaviors.

For example, the base map may include a small group conferencing region for users to participate in distance-based video conferencing amongst small groups. That is, each participant exchanges media streams with at most a threshold number of the other nearest participants in the region, rather than with all the participants in the region. Generally, a majority of the map area may be designated as a small group conferencing region unless otherwise specified. The small group conferencing region may be particularly effective to mimic in-person networking, in which users may move around the space and join conversations as they near other participants.

The base map may further include a large group conferencing region for large groups to participate in video conferencing amongst all participants in the region. That is, each of the participants may exchange media streams with each other participant in the large group conferencing region. The large group conferencing region may be particularly effective, for example for virtual brainstorming sessions, in which each member of the large group may contribute and listen to the ideas as a collective.

The base map may further include a broadcasting region for a single presenter or a small group of presenters to broadcast to an audience (i.e., a group of participants or audience members). That is, each of the audience members receives media streams from each presenter, but does not provide a media stream to the presenter (i.e., the media stream exchange is unidirectional). The broadcasting region may be particularly effective for presentations, teaching sessions, performances, and the like.

As will be appreciated, in some examples, the communications behaviors described above need not be solely linked to the particular regions; for example, at a designated time, a presenter may broadcast a media stream to all the participants in the video conferencing session, irrespective of their position and/or corresponding region on the base map.

The session database 216 may further include participant information for the session, including account identifiers for accounts participating in a given session, position data associated with each participant and the like. The participants for a session may further be associated with a participant identifier to define the accounts in context of the given session and to enforce the permitted number of participants in the session. Further, in some examples, participants may form groups, and accordingly, the session database 216 may further store group information, including a group identifier and associated participant identifiers for a given group, and the like.

The memory 204 may also store an account database to manage client accounts (e.g., including personal account information, login information, passwords, user preferences, and the like).

The control server 104 also includes the communications interface 208 interconnected with the processor 200. The communications interface 208 may be configured for wireless or wired communications and may include suitable hardware (e.g., transmitters, receivers, network interface controllers, and the like) to allow the control server 104 to communicate with other computing devices, such as the client device 108 and the participant devices 112. The specific components of the communications interface 208 are selected based on the type of communication links 116 that the control server 104 communicates over.

In some examples, the control server 104 may further include one or more input and/or output devices (not shown), such as a monitor, display, keyboard, mouse, speakers, or the like to allow a user to interface with the control server 104.

The client device 108 includes a processor 220 interconnected with a non-transitory computer-readable storage medium, such as a memory 224, a communications interface 228, one or more input devices 232 and one or more output devices 236.

The processor 200 may include a central processing unit (CPU), a microcontroller, a microprocessor, a processing core, a field-programmable gate array (FPGA) or similar. The processor 220 may include multiple cooperating processors. The processor 220 may cooperate with the memory 224 to realize the functionality discussed herein.

The memory 224 may include a combination of volatile (e.g. Random Access Memory or RAM) and non-volatile memory (e.g. read only memory or ROM, Electrically Erasable Programmable Read Only Memory or EEPROM, flash memory). All or some of the memory 224 may be integrated with the processor 220. The memory 224 stores applications, each including a plurality of computer-readable instructions executable by the processor 220. The execution of the instructions by the processor 220 configures the client device 108 to perform the actions discussed herein. In particular, the applications stored in the memory 224 include a video conferencing application 240 to enable video conferencing with one or more of the participant devices 112.

The client device 108 also includes the communications interface 228 interconnected with the processor 220. The communications interface 228 may be configured for wireless or wired communications and may include suitable hardware (e.g., transmitters, receivers, network interface controllers, and the like) to allow the client device 108 to communicate with other computing devices, such as the control server 104 and the participant devices 112. The specific components of the communications interface 228 are selected based on the types of communication links 116 that the client device 108 communicates over.

The client device 108 further includes the input devices 232. The input devices 232 may include one or more of a keyboard, mouse, touchscreen display, or the like to allow a user of the client device 108 to provide input to the client device 108, for example to provide input during execution of the video conferencing application 240 during a video conference. The input devices 232 may further include a webcam and a microphone to capture image or video data and audio data respectively, of the user of the client device 108 during the video conference.

The client device 108 further includes the output devices 236. The output devices 236 may include one or more of a display, a monitor, speakers, vibrators and the like to output various signals or data from the client device 108. In particular, the output device 236 may include a display to display video data during a video conference, and speakers to output audio data during the video conference.

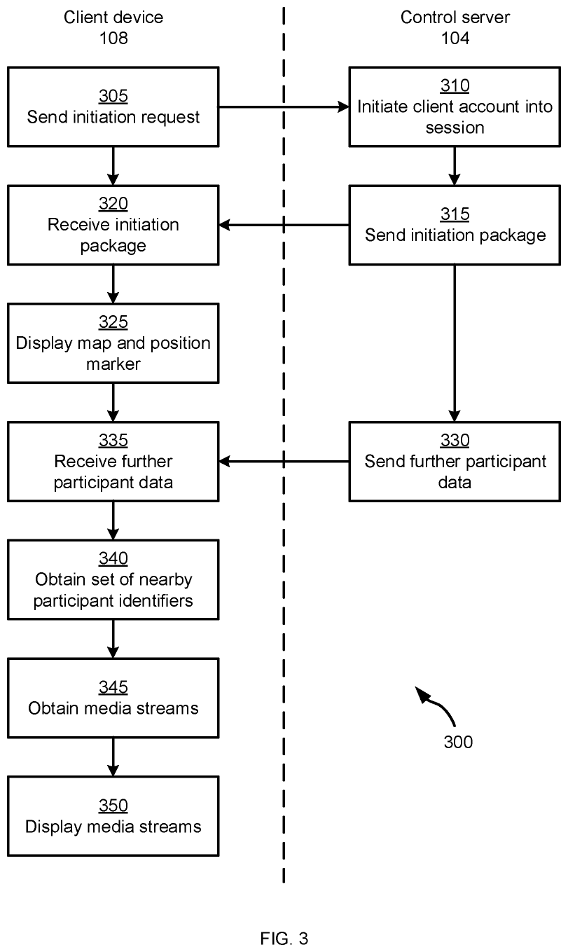

Referring now to FIG. 3, a flowchart of an example method 300 of video conferencing is depicted. The method 300 will be described in conjunction with its performance in the system 100, and in particular, by the control server 104 via execution of the application 212 by the processor 200 and the client device 108 via execution of the application 240 by the processor 220. In other examples, the method 300 may be performed by other suitable devices and/or systems.

The method 300 is initiated at block 305. At block 305, the client device 108 sends an initiation request to the control server 104 to initiate a video conferencing session. For example, the initiation requests may be based on input provided to the client device 108 by a user of the client device 108. In particular, the initiation request may be sent by the client device 108 to the control server 104 via the communication link 116, which may be, for example, a web socket connection to allow efficient and secure communications between the client device 108 and the control server 104.

For example, the user of the client device 108 may first log in to a client account at the control server 104. The client account may therefore be associated with the client device 108. Once logged in to the client account, in one example, the user may request set up of a new video conferencing session. Accordingly, the initiation request sent by the client device 108 to the control server 104 may include a new session request, including a size of the video conferencing session (e.g., a permitted number of participants), security information for the video conferencing session (e.g., a password to allow participants into the session), a selected base map, and the like. In another example, the user may request to join an existing video conferencing session. Accordingly, the initiation request sent by the client device 108 to the control server 104 may include an existing session identifier and a join request. As will be appreciated, the initiation request may also include an account identifier for the client account and other relevant client device information, such as a device identifier, video and audio capabilities, communications protocol capabilities, and the like.

At block 310, in response to the initiation request, the control server 104 initiates the client account into a video conferencing session.

For example, when the initiation request includes a new session request, the control server 104 may define a new session in the session database 216. In particular, the control server 104 may define the new session based on the size, security information and other data received in the initiation request. The control server 104 may further define a base map for the session, for example, based on a selected map in the new session request, or based on a default map. The control server 104 may further propagate the new session data to various communications servers, to allow the client device 108 to stream media in the video conferencing session, as will be described in greater detail below. In some examples, when the requested size exceeds a threshold size supported by the communications server(s), the control server 104 may manage state synchronization across a plurality of stateful clusters for a larger session size.

After initiating the new session, or when the initiation request includes a join request for an existing session, the control server 104 initiates the requesting client account into the session. That is, the control server 104 may define the client account as a participant in the session and store the relevant information in the session database 216. More particularly, the control server 104 may associate retrieve, for the client account specified in the initiation request, an account identifier associated with the client account. The control server 104 may then associate the account identifier with the session identifier and define a client participant identifier to represent and contextualize the client account within the session. The control server 104 may then define a position for the client account and associate the position with the account identifier and client participant identifier. The position of the client account may be defined, for example, based on a default entry position for new participants in a session defined based on the base map. In particular, the positions of accounts are defined relative to the base map in a continuous context. That is, the positions may be represented as X- and Y-coordinates or another suitable continuously defined position within the base map.

At block 315, after initiating the client account into the video conferencing session, the control server 104 sends an initiation package to the requesting client device 108. The initiation package includes data pertaining to the session to allow the client device 108 to connect to the session. In particular, the initiation package includes the client participant identifier representing the client account within the session, the base map for the session (e.g., as defined in the session information in the session database 216), and the position of the client account.

At block 320, the client device 108 receives the initiation package.

At block 325, the client device 108 extracts the base map definition and the position of the client account and displays the base map and a position marker on the base map, for example at a display of the output devices 236. In particular, the position marker represents the position of the client account on the base map, as defined in the initiation package. The position marker may be a default marker, such as a circle or other suitable shape, or another avatar. For example, the user may be able to define, in the user's account, an avatar or representation for the position marker, including defining a photo for use, a shape and fill, or the like.

At block 330, after having sent the initiation package to the client device 108, the control server 104 sends further participant data to the client device 108. In particular, the further participant data may include participant identifiers for other participant accounts in the session as well as respective positions for each of the participant accounts.

At block 335, the client device 108 receives the further participant data. In some examples, the client device 108 may additionally display participant position markers on the base map, representing the respective positions of the other participant accounts on the base map. The participant position markers may be a default marker, or other suitable shape, avatar, or the like representing the participant account. In some examples, the participant position markers may be scaled down to be smaller than the position marker of the client account, or otherwise differently represented (e.g., having different outlines, opacity, or the like), to allow the user of the client device 108 to easily identify his or her own position on the base map.

At block 340, the client device 108 obtains a set of nearby participant identifiers representing participant accounts selected based on a proximity of the respective positions of the participant accounts to the position of the client account received at block 335. In some examples, the set of nearby participant identifiers may be selected based on participant accounts within a threshold distance of the client account. That is, the nearby participant identifiers in the set may represent participant accounts within a predefined threshold distance of the client account.

Further, in some examples, the set of nearby participant identifiers may alternately or additionally be restricted by a threshold number of nearby participant accounts. For example, it may be impractical to display more than about six video streams, and hence the client device 108 may select the nearest five neighbors (e.g., to have six video streams including displaying the client account video stream), or the top five nearby participant identifiers in the ordered list of nearby participant identifiers as the set. As will be appreciated, in other examples, other threshold numbers may be utilized. The threshold number of nearby participants may be set, in some examples, based on the region type in which the client account is positioned.

For example, to select the set of nearby participant identifiers, the client device 108 may apply a k-nearest neighbors classification, with k equal to the threshold number of nearby participant accounts, to the participant accounts to classify the participant accounts into classes of at most the threshold number. The classes of participant identifiers may be additionally restricted in that each of the participant accounts in a given class is to be at most the threshold distance apart. That is, each class includes participant identifiers which are “nearby” to one another. Thus, each nearby participant identifier corresponds to nearby participant account having a respective position within a threshold distance of the position of the client account, as well as within the threshold distance to one another. The distance may be computed, for example, based on a Euclidean distance between two positions, when the positions are provided on an XY-coordinate plane. In other examples, other suitable distance computations are also contemplated. The client device 108 may thus select, as the set of nearby participant identifiers, the participant identifiers corresponding to the participant accounts in the class of the client account.

In some examples, the client device 108 may additionally consider groups (described further below) of participant accounts which are linked to always be in the same class. In such examples, the client device 108 may receive group lists from the control server 104 to account for the groups during the k-nearest neighbor classification.

As will be appreciated, in other examples, the classification of participant accounts into classes and restriction by the threshold distance may be performed by the control server 104. Accordingly, to obtain the set of nearby participant identifiers, the client device 108 may simply request and/or receive the set of nearby participant identifiers from the control server 104. In some examples, the set of nearby participant identifiers may be sent concurrently with the further participant data at block 335. In particular, the classification of participant accounts may be performed at the control server 104 to facilitate the management of groups of linked participant accounts.

In other examples, other restrictions or considerations may be applied to select the set of nearby participant identifiers sent to the client device 108.

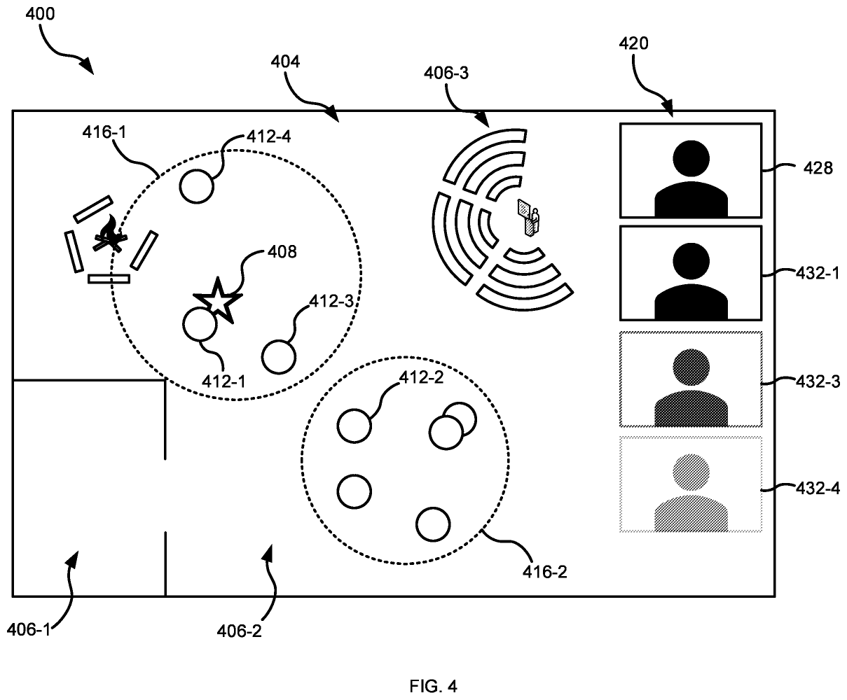

For example, referring to FIG. 4, a schematic of an example video conferencing session 400 is depicted. The video conferencing session 400 is displayed at the client device 108 and includes a base map 404 upon which various features are depicted. In particular, the base map 404 may include various regions 406, such as a large group conferencing region 406-1 for large groups to participate in video conferencing (as described further below), a small group conferencing region 406-2 for users to navigate and participate in video conferencing amongst small groups of about six participants, and a presentation region 406-3 for a single presenter to broadcast to a group of participants (as described further below). As will be appreciated, in other examples, the base map 404 may include more or fewer regions and region types, and/or the regions may not be explicitly depicted. Additionally, the specific conferencing functionality of the various regions may not be restricted to the particular regions. For example, at a designated time, a single presenter may broadcast to all the participants in the session 400, irrespective of the position of the participants (i.e., the participants need not be in the presentation region 406-3 to receive the presenter's broadcasted media stream).

The video conferencing session 400 further includes a position marker 408 representing the position of the client account associated with the client device 108, as well as position markers 412-1, 412-2, 412-3, and 412-4 representing the respective positions of the participant accounts associated with the participant devices 112-1, 112-2, 112-3, and 112-4, respectively. Additional position markers for further participant accounts are also depicted. As the position markers 408 and 412 represent the position of the respective accounts, the expression position markers may be used interchangeably to mean the position of the respective accounts and/or the respective accounts themselves.

Based on the k-nearest neighbor classification, the participant accounts may be separated into a first class 416-1, including the client account represented by the position marker 408 and the first, third and fourth participant accounts represented by the position markers 412-1, 412-3, and 412-4, and a second class 416-2, including the second participant account represented by the position marker 412-2 and a plurality of further participant accounts represented by the additional position markers.

Returning to FIG. 3, at block 340, the client device 108 obtains media streams for the participant accounts associated with the participant identifiers in the set of nearby participant identifiers obtained at block 335. The client device 108 may obtain and exchange media streams with the participant accounts from a central communications server (e.g., a selective forwarding unit, or SFU, server), or directly from the participant devices 112 in a peer-to-peer exchange network, based on the media exchange system of the system 100. As will be appreciated, in some examples, the system 100 may employ a combination of media exchange systems, including some media streams exchanged via a central communications server, and some media streams exchanged via a peer-to-peer exchange network, or other suitable media exchange systems. For example, the system and method of media exchange may vary based on the communications behavior of the various region types on the map area.

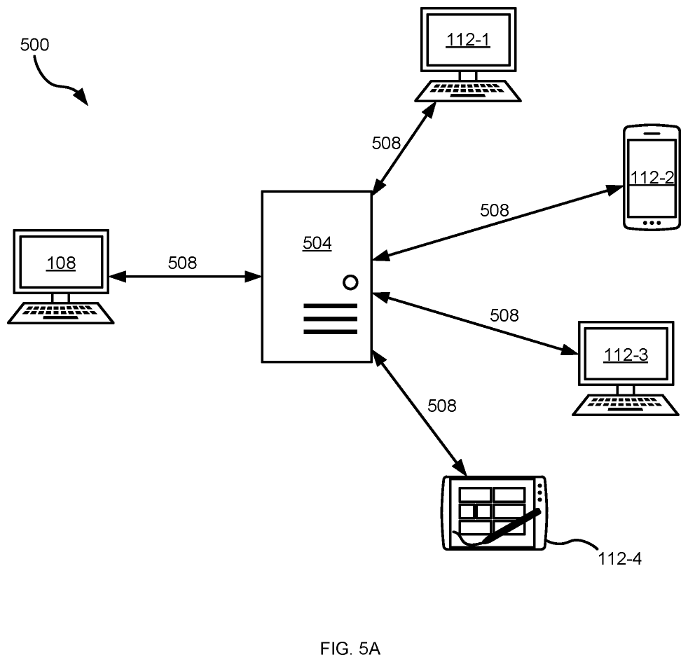

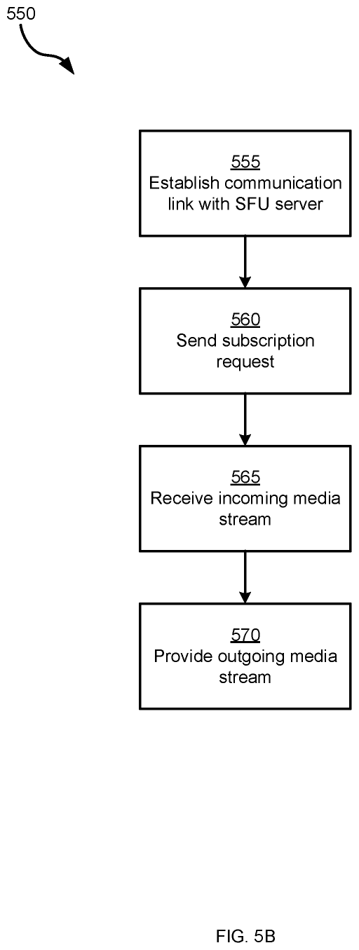

For example, referring to FIG. 5A, an example media exchange system 500 is depicted. In particular, the media exchange system 500 includes a selective forwarding unit (SFU) server 504 to manage the selective forwarding of media streams to the client device 108 and the participant devices 112. In some examples, the functionality of the SFU server 504 may be implemented on any suitable server environment, including a plurality of cooperating servers, a cloud-based server environment, or the like. The SFU server 504 is in communication with the client device 108 and the participant devices 112 via communication links 508. The communication links 508 may be wired or wireless or a combination of wired and wireless communication links. For example, the communication links may be provided by a wireless local area network (WLAN) deployed by one or more access points (not shown). In other examples, the communication links 508 may include one or more wide-area networks such as the Internet, mobile networks, combinations of the above, and the like.

In operation, the SFU server 504 may receive media streams from each of the client device 108 and the participant devices 112. Each of the client device 108 and the participant devices 112 may additionally request a set of media streams based on nearby accounts. In response to such requests, the SFU server 504 may selectively forward the requested media streams to be output at the respective devices.

Turning to FIG. 5B, a flowchart of an example method 550 of obtaining media streams is depicted.

At block 555, the client device 108 establishes the communication link 508 with the SFU server 504. For example, the client device 108 may establish a web socket connection with the SFU server 504, as well as perform an interactive connectivity establishment (ICE) negotiation with the SFU server 504 to allow media streams to be passed back and forth efficiently and in near real-time between the client device 108 and the SFU server 504.

At block 560, the client device 108 sends a subscription request to the SFU server 504 for a media stream. In particular, the subscription request includes a participant identifier for an endpoint participant account whose media stream is to be output at the client device 108. For example, the participant identifier may be one of the nearby participant identifiers in the set of nearby participant identifiers obtained at block 340 of the method 300. In other examples, the participant identifier may correspond to a presenter broadcasting their media stream (as will be described further below).

At block 565, the client device 108 receives an incoming media stream corresponding to the participant identifier from the subscription request at block 560. In particular, the incoming media stream may include a video stream and an audio stream, as available.

At block 570, the client device 108 may additionally provide an outgoing media stream to the SFU server 504. In particular, the outgoing media stream may include a video stream and an audio stream captured by the input devices 232 at the client device 108. The client device 108 may additionally provide the client participant identifier associated with the client account to be associated with the outgoing media stream for identification purposes.

Thus, the client device 108 may exchange media streams with other endpoint participant devices, including both receiving an incoming media stream, as well as providing an outgoing media steam, which may be subsequently forwarded by the SFU server 504 to the endpoint participant device. As will be appreciated, blocks 560 and 565 may be appreciated for multiple endpoint participant accounts whose media streams are to be output at the client device 108, based, for example, on the set of nearby participant identifiers.

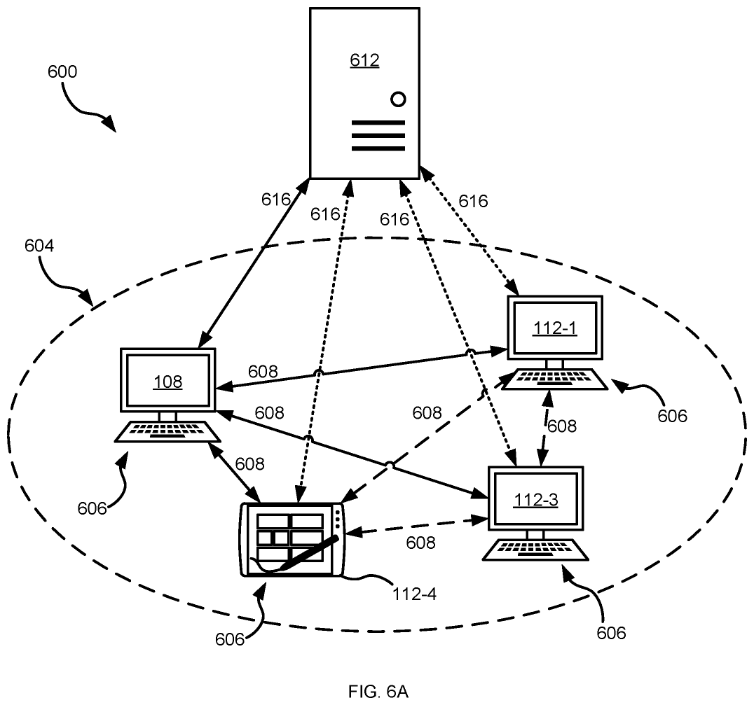

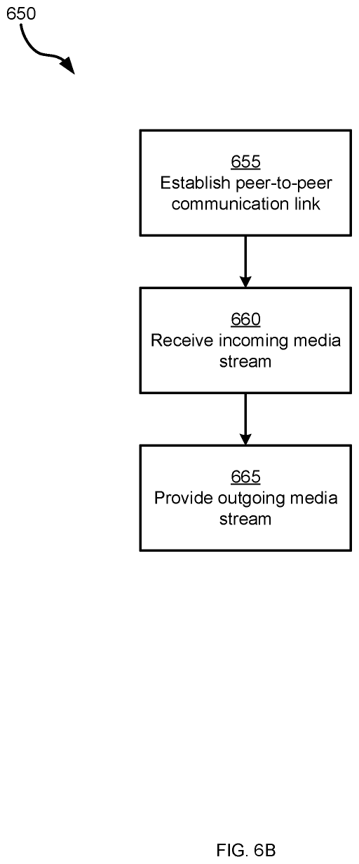

Referring to FIG. 6A, another example media exchange system 600 is depicted. In particular, the media exchange system 600 includes a peer-to-peer network 604 established between the client device 108 and a subset of the participant devices 112. In the present example, the peer-to-peer network 604 represents the class 416-1. The client device 108 and each of the participant devices 112-1, 112-3, and 112-4 are also referred to herein as nodes 606 of the peer-to-peer network 604 and are in communication with one another via communication links 608. The communication links 608 may be wired or wireless or a combination of wired and wireless communication links. For example, the communication links 608 may be provided by a wireless local area network (WLAN) deployed by one or more access points (not shown). In other examples, the communication links 608 may include one or more wide-area networks such as the Internet, mobile networks, combinations of the above, and the like. In operation, the client device 108 may exchange media streams with each of the participant devices 112 and any further nodes 606 in the network 604 individually.

In order to establish the peer-to-peer communication links 608, the media exchange system 600 further includes a communications server 612. The communications server 612 may include multiple cooperating servers, including a STUN/TURN server and a signaling server with which the nodes 606 of the network 604 may communicate in order to determine the relevant information to establish the direct peer-to-peer communication links 608. That is, the nodes 606 of the network 604 are in communication with the communications server 612 via communication links 616.

Turning now to FIG. 6B, a flowchart of an example method 650 of obtaining media streams is depicted. The method 650 will be described in conjunction with its performance by the client device 108 via execution of the application 240 by the processor 220. In other examples, the method 650 may be performed by other suitable devices and/or systems. For example, the method 650 may be performed by each of the participant devices 112 in the network 604. Further, the method 650 is described in conjunction with its performance by the client device 108 with respect to the first participant device 112-1. It will be appreciated that the method 650 may repeated for each nodes 606 and by each of the nodes 606 in the network 604.

At block 655, the client device 108 establishes the peer-to-peer communication link 608 with the first participant device 112-1. For example, the client device 108 may first exchange one or more messages with the communications serer 612 to obtain the relevant connection information for the client device 108 to establish a connection with the participant device 112-1. The client device 108 may subsequently establish the link 608 with the participant device 112-1.

At block 660, the client device 108 receives an incoming media stream from the participant device 112-1. In particular, the incoming media stream may include a video stream and an audio stream, as available.

At block 665, the client device 108 may additionally provide an outgoing media stream to the participant device 112-1. In particular, the outgoing media stream may include a video stream and an audio stream captured by the input devices 232 at the client device 108.

Thus, the client device 108 may exchange media streams with the participant device 112-1, including both receiving an incoming media stream as well as providing an outgoing media stream. As noted above, the client device 108 may repeat the method 650 for the participant devices 112-3 and 112-4 and any other nodes in the peer-to-peer network 604.

Returning to FIG. 3, at block 350, after having obtained the media streams, the client device 108 outputs the media streams at the client device 108, and particularly, at the output devices 236. For example, the client device 108 may display a video stream portion of the media stream at a display, and provide an audio stream portion of the media stream at a speaker.

In some examples, the client device 108 may further adjust output of the media stream based on a distance of the corresponding participant account from the client account. That is, the media stream of a participant account having a respective position closer to the position of the client account may be more heavily weighted (e.g., having greater opacity and volume) than the media stream of a participant account having a respective position further from the position of the client account. For example, the opacity of the video stream portion may be linearly proportional to the distance between the participant account and the client account, with the threshold distance being an endpoint (i.e., wherein at the threshold distance, the opacity of the video stream is zero or substantially zero). The volume of the audio stream portion may likewise be linearly proportional to the distance between the participant account and the client account. In other examples, other weightings (i.e., other than linear proportionality) and other manners of applying the weightings (i.e., other filters and/or effects than opacity and volume) are contemplated.

For example, referring again to FIG. 4, the video conferencing session 400 includes a media stream display region 420 overlaid on the base map 404. The media stream display region 420 may, in some examples, expand and contract based on the number of media streams to display. In the present example, the display region 420 includes a video streams for each of the accounts in the class 416-1, of which the client account is a member. Thus, the display region 420 includes a client video stream 428, as well as video streams 432-1, 432-3, and 432-4 corresponding to the first, third and fourth participant accounts.

Further, the opacity of the video streams 432 are proportional to the distance of the respective participant account to the client account. In particular, the position marker 412-1 of the first participant account is partially overlapping with the position marker 408 of the client account, and hence the position of the first participant account may be the same as, within a small radius of the position of the client account. Accordingly, the first participant video stream 432-1 is shown at full opacity. Similarly, the audio stream corresponding to the first participant account may be played at full volume. The position marker 412-3 of the third participant account is further from the position marker 408 of the client account, for example, at about 40% of the threshold distance, and accordingly the third participant video stream 432-3 is shown at 60% opacity. Similarly, the audio stream corresponding to the third participant account may be played at about 60% volume. The position marker 412-4 of the fourth participant account is still further from the position marker 408 of the client account, for example at about 75% of the threshold distance, and accordingly the fourth participant video stream 432-4 is shown at 25% opacity. Similarly, the audio stream corresponding to the fourth participant account may be played at about 25% volume.

The user may thus participate in distance-based video conferencing, with media streams weighted based on the distance between participants. Advantageously, this allows users to more clearly hear and see other participants who are nearby, to more closely represent an in-person experience. Further, by providing a distance basis, video conferencing may be restricted to a threshold number of participants for a smaller, more intimate group without restricting users to discrete rooms.

In some examples, the system 100 may further support a broadcast within the video conferencing session. In particular, a broadcast allows a single presenter or a small group of presenters to broadcast their stream to all or a subset of the participants (audience members) in the video session, irrespective of the distance between the presenter and the audience members. During a broadcast, the exchange of media streams is one-way; that is, audience members receive the media stream(s) of the presenter(s), but the presenter(s) do not receive the media streams of the audience members.

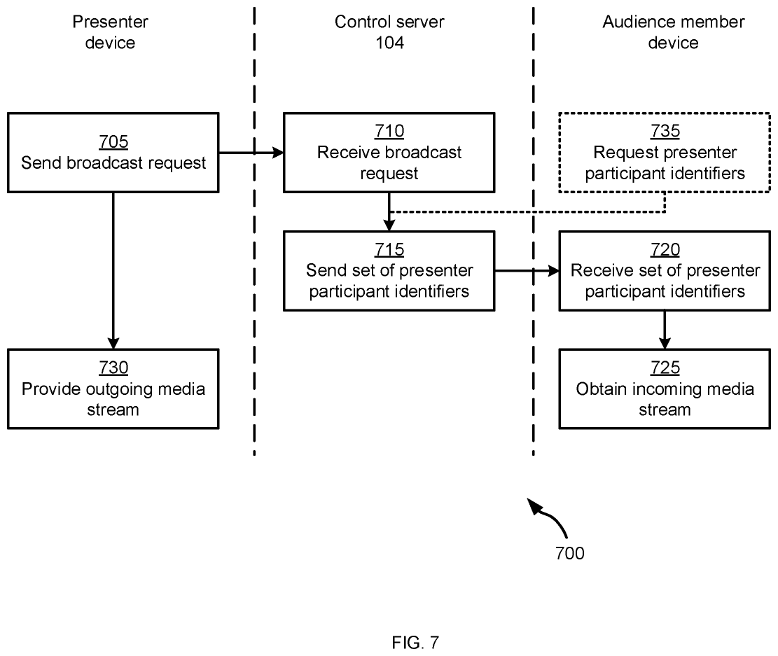

For example, referring to FIG. 7, a flowchart of an example method 700 of effecting a broadcast is depicted. The method 700 will be described in conjunction with its performance by a presenter device, the control server 104, and an audience member device. As will be appreciated, the client device 108 may serve as either the presenter device or the audience member device in different examples. Similarly, each of the participant devices 112 may serve as either the presenter device or the audience member device. Further, it will be appreciated that the portion of the method 700 executed by the audience device may be executed by each member of the audience (i.e., each of the client device 108 and the participant devices 112 which are not presenting).

The method 700 is initiated at block 705. At block 705, the presenter device sends a broadcast request to the control server 104. The broadcast request may include a time of the broadcast, identifiers of other joint presenter devices (e.g., if two or more users are performing a joint broadcast from two or more separate devices), and other relevant information.

At block 710, the control server 104 receives the broadcast request and proceeds to block 715 to process the broadcast request. In some examples, prior to proceeding to block 715, the control server 104 may first verify credentials of the presenter device and the joint presenter devices to confirm that the devices are permitted to perform broadcasts. For example, permissions to broadcast may be controlled on an account basis to control abuse of the broadcast functionality.

At block 715, the control server 104 obtains a set of presenter participant identifiers of the presenter device and any other joint presenter devices and sends the set of presenter participant identifiers to each of the audience member devices. In particular, the audience member devices may be each device participating in the video conferencing session which is not designated as the presenter device or a joint presenter device. In some examples, when the broadcast request specifies a time of the broadcast, the control server 104 may delay execution of the block 715 until the specified time.

At block 720, the audience member device receives the set of presenter participant identifiers and proceeds to block 725 to process the set of presenter participant identifiers.

At block 725, the audience member device obtains broadcasted media streams for the presenter participant accounts associated with the presenter participant identifiers in the set of presenter participant identifiers received at block 720. In some examples, the audience member device may obtain the media streams from a central communications server (e.g., an SFU server, such as the SFU server 504), for example via execution of the method 550. However, the audience member device may omit the performance of the block 570, as media is streamed from the presenter devices to the audience member devices in a one-way manner. In other examples, the audience member device may obtain the media streams directly from each of the presenter devices in a peer-to-peer exchange network, such as the network 604, for example via execution of the method 650. However, the audience member device may similarly omit the performance of the block 665. In other examples, the audience member devices may form a peer-to-peer exchange network, for example, based on proximity of the devices. Further, rather than forming a peer-to-peer connection with the presenter device directly, the audience member devices may propagate the media stream through the peer-to-peer network until all audience member devices receive the media stream. Thus, the audience member device may obtain the presenter's incoming media stream from a nearby audience member device.

Simultaneously or prior to block 725, at block 730, the presenter device initiates an outgoing media stream, including, for example a video stream and an audio stream captured by the input devices (e.g., a camera and a microphone) at the presenter device. According to an example, the presenter device may provide the outgoing media stream to the SFU server 504 for forwarding to the audience member devices. The presenter device may additionally provide the presenter participant identifier for identification purposes. In other examples, the presenter device may provide the outgoing media stream to adjacent nodes 606 in the peer-to-peer network 604. The adjacent nodes 606 may include each of the audience member devices, or the adjacent nodes 606 may represent nearby audience member devices, which may subsequently propagate the outgoing media stream to other nearby audience member devices until the outgoing media stream has propagated through the network 604. Thus, the media stream captured at the presenter device is provided to each of the audience member devices to enable the broadcast.

In some examples, such as when a user joins a broadcast in progress, for example by navigating into a broadcasting region (as will be described further below), the audience member device may, at block 735 send a request for the presenter participant identifiers to the control server 104. In response to such a request, the control server 104 sends the set of presenter participant identifiers at block 715, and the method 700 proceeds accordingly.

As noted above, the system 100 provides a continuously navigable video conferencing session, in which users may navigate on a continuous map. In particular, a user may provide input at the client device 108 to change the position of the client account to move between different regions of the map area, or towards and away from other participants on the map area, as represented by the respective position markers.

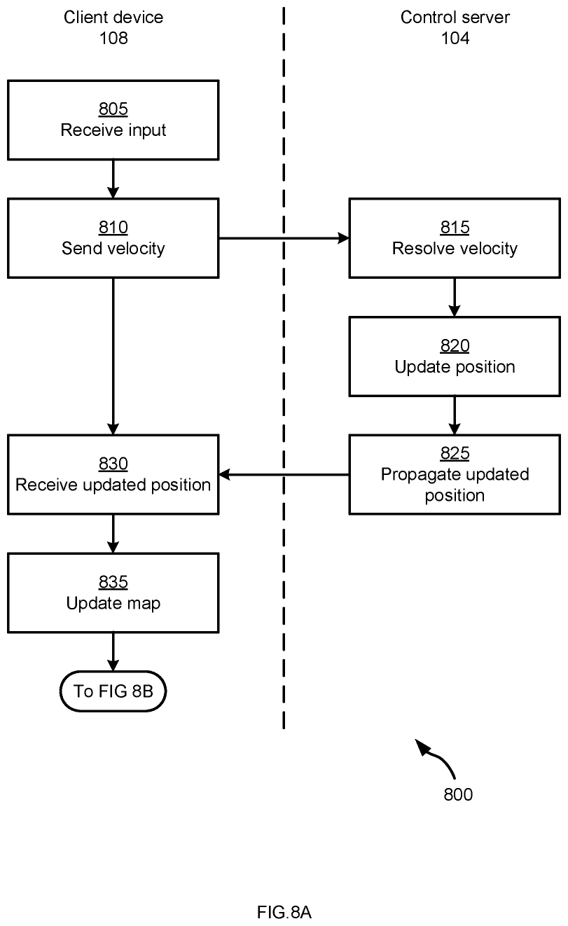

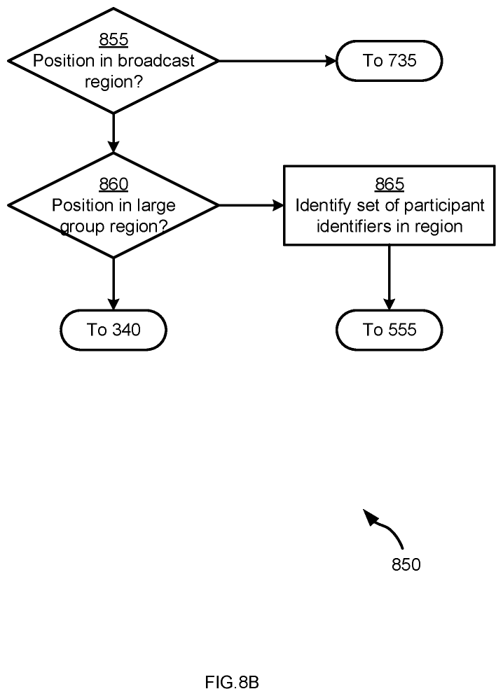

For example, referring to FIG. 8A depicts a flowchart of an example method 800 of navigating around a video conferencing session. The method 800 will be described in conjunction with its performance in the system 100, and in particular, by the control server 104 via execution of the application 212 by the processor 200 and the client device 108 via execution of the application 240 by the processor 220. In other examples, the method 800 may be performed by other suitable devices and/or systems.

At block 805, the client device 108 receives an input at one of the input devices 232. In particular, the input may be indicative of a desired direction of movement of the position marker 408. For example, the input may be received at a keyboard based on a key press (e.g., a up/down/left/right arrow key, or other keys assigned to represent the directionality), at a pointing stick, track pad, or joystick, by selection of buttons or other interactive components at a graphical user interface, or the like.

At block 810, the client device 108 sends the direction indicated by the input as a velocity to the control server 104. For example, the velocity may include the direction as well as a magnitude, determined, for example, based on a length of the key press, or similar. In other examples, the magnitude of the velocity may be set to a default magnitude. As will be appreciated, the velocity may be accompanied by the client participant identifier to allow the control server 104 to process the velocity.

At block 815, the control server 104 receives the velocity from the client device 108 and proceeds to block 820 to process the velocity.

At block 820, the control server 104 uses the velocity received at block 815 to update the position of the client account. In some examples, the velocity may simply be applied to the most recent position of the client account. In particular, the velocity may be applied to the scale of the map, and the XY-coordinates of the client account may be updated. In other examples, the respective positions of other accounts may also be taken into consideration. For example, each client account or position marker may be defined to occupy a space on the map, at its position, without overlapping other participant accounts or position markers. Accordingly, in such examples, the control server 104 may define various positioning rules when the client accounts or position markers may overlap based on the provided velocities. That is, the control server 104 applies deterministic control over the positions of the client accounts within the map to avoid conflict.

At block 825, after having determined an updated position for the client account, the control server 104 propagates the updated position. In particular, the control server 104 sends the updated position to the client device 108, as well as to the other participant devices 112 in the video conferencing session.

At block 830, the client device 108 receives the updated position. As will be appreciated, the other participant devices 112 may similarly receive the updated position of the client account.

At block 835, the client device 108 updates the position marker to reflect the updated position on the displayed map. As will be appreciated, the other participant devices 112 may similarly update the position marker of the client account to reflect the updated position of the client account displayed on respective maps at the participant devices 112.

Referring to FIG. 8B, a flowchart of an example method 850 of updating media streams at the client device 108 is depicted.

The method 850 is initiated at block 855 in response to any number of changes in state or position of the client account or changes in state or position of other participant accounts. For example, the method 850 may continue from block 835 of the method 800. In other examples, the method 850 may be initiated in response to receiving updated participant data (e.g., addition of a new nearby participant, or movement of nearby participants, and the like. At block 855, the client device 108 determines whether the updated position corresponds to a broadcast region.

If the determination at block 855 is affirmative, the client device 108 proceeds to block 735 of the method 700 to request the presenter participant identifiers to join a broadcast in progress. As will be appreciated, in some examples, no broadcast may be in progress, and hence the client device 108 may not display any media stream until the user navigates out of the broadcast region.

If the determination at block 855 is negative, the client device 108 proceeds to block 860. At block 860, the client device 108 determines whether the updated position corresponds to a large group region.

If the determination at block 860 is affirmative, the client device 108 proceeds to block 865. At block 865, the client device 108 obtains a set of large group region participant identifiers. For example, the client device 108 may determine, based on the base map definition and the further participant data provided to the client device 108, the participant identifiers corresponding to participant accounts having positions within the large group region.

After having obtained the set of large group region participant identifiers, the client device 108 proceeds to block 555 of the method 550 to exchange media streams with each of the participant devices corresponding to the large group region participant identifiers. In particular, the large group region may employ an SFU server to exchange media streams in order to support larger groups without undue replication of exchanged media streams, as would be incurred with a peer-to-peer network.

If the determination at block 865 is negative, the client device 108 proceeds to block 340 of the method 300 to obtain a set of nearby participant identifiers and exchange media streams in a distance-based and small group manner. In particular, based on the movement or change in states of the nearby participant accounts, the client device 108 may obtain a different set of nearby participant identifiers at a subsequent iteration of block 340.

The user may thus navigate between different regions, as well as towards and away from other participants. Advantageously, movement within the map area is continuous and hence provides a more fluid video conferencing experience, particularly when coupled with distance-based media stream weightings.

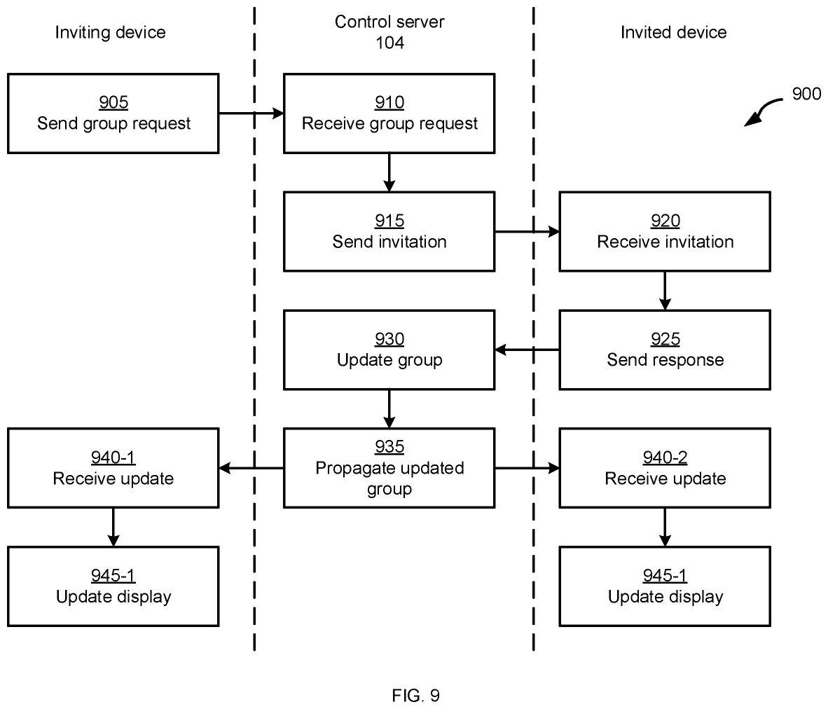

In some examples, two participants may wish to navigate the map together to continue conferencing with each other. The system 100 may therefore support grouping to allow the participants to form a group and have their positions and media streams locked together. For example, FIG. 9 depicts a flowchart of an example method 900 of forming a group. The method 900 will be described in conjunction with its performance by an inviting device, the control server 104, and an invited device. As will be appreciated, the client device 108 may serve as either the inviting device or the invited device in different examples. Similarly, each of the participant devices 112 may serve as either the inviting device or the invited device.

At block 905, the inviting device sends a group request to the control server 104. For example, the group request may be sent in response to an input at the inviting device provided by a user of the inviting device. For example, when clicking or hovering over a video stream of another user in the media stream display region, the inviting device may display an overlay including options for the user to create or join a group with the invited participant account of the video stream. The group request may be to create a new group, for example if the inviting device is not part of an existing group, or an invitation for the invited participant account to join an existing group of the inviting participant account. The group request may further include the participant identifier associated with the inviting device (i.e., the inviting participant identifier) and the participant identifier obtained based on the video stream from which the group request was initiated (i.e., the invited participant identifier).

At block 910, the control server 104 receives the group request. In examples where the group request is for a new group, the control server 104 may define a new group in the session database 216. The group may be defined by a group list of member participant identifiers, initially defined to include only the inviting participant identifier.

At block 915, the control server 104 sends an invitation to join a group to the invited device based on the invited participant identifier from the group request.

At block 920, the invited device receives the invitation. The invitation may be displayed at a display of the invited device, for example in a pop-up window, or the like for a user to accept or decline the invitation. That is, groups are joined by an opt-in process from all members of the group.

At block 925, the invited device sends a response to the control server 104. The response may include an indication of acceptance or rejection of the invitation.

At block 930, the control server 104 receives the response and updates the group based on the response. In particular, if the response is an acceptance of the invitation, the control server 104 may update the group list to include the invited participant identifier. The control server 104 may further update the position of the invited participant account to be the same as the position of the inviting participant account, to group the positions of each of the group members. If the response is a rejection of the invitation, the control server 104 may not perform any action, as the group may not change. In instances where the inviting participant is the only remaining group member, the control server 104 may dissolve the group.

At block 935, the control server 104 propagates the updated group data to the inviting device and the invited device, as well as any other group member devices. In particular, the updated group data may include the group list of member participant identifiers as well as updated positions for each group member device (e.g., the updated position of the invited device, if the invited device has joined the group and has had its position updated to match the position of the other group members).

At blocks 940-1 and 940-2, the inviting device and the invited devices receive the updated group data. As will be appreciated, other group member devices may similarly receive the updated group data.

At blocks 945-1 and 945-2, the inviting device and the invited devices update the position markers to reflect any updated positions on the displayed maps. In particular, when the invited participant account joins the group and shares a position with the inviting participant account, the position markers of the group members may be partially overlaid and centered about the position of the group (i.e., the position of each of the group members). As will be appreciated, the other group member devices may similarly update the position marker of a newly included invited participant account. Further, as will be appreciated, as the group member accounts share a position, the weighting of the media streams for group members may be set to full opacity and full volume.

As will be appreciated, having updated a position of a participant account, the updated position may prompt a re-iteration of the method 850 by each of the participant devices, including the inviting device and the invited device, as well as the client device 108 to determine which media streams to display.

For example, referring again to FIG. 4, the client account and the first participant account may be grouped, and hence the respective position markers 408 and 412-1 are partially overlaid.

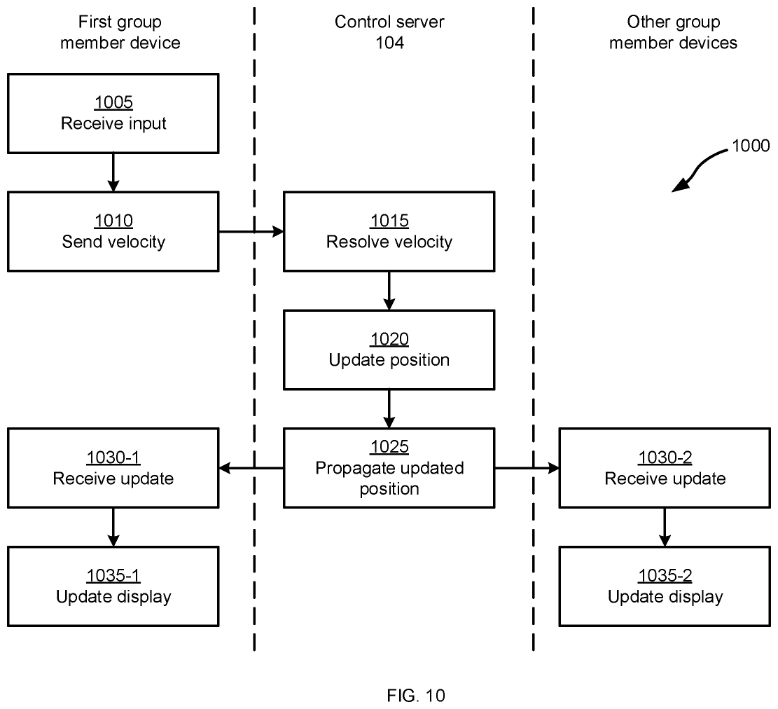

Once in a group, each group member may control the navigation capabilities of each member of the group. For example, referring to FIG. 10, a flowchart of an example method 1000 of navigating the map in the context of a group is depicted. The method 1000 will be described in conjunction with its performance by a first group member device, the control server 104 and the other group member devices. As will be appreciated, the portion of the method 1000 executed by the first group member device may be executed by any of the group member devices (e.g., by the client device 108, or any of the participant devices 112). That is, any participant account which has joined a group may perform the function of the first group member device, or experience the effects by the other group member devices.

At block 1005, the first group member device receives an input at one of the input devices. In particular, the input may be indicative of a desired direction of movement. For example, the input may be received at a keyboard based on a key press (e.g., a up/down/left/right arrow key, or other keys assigned to represent the directionality), at a pointing stick, track pad, or joystick, by selection of buttons or other interactive components at a graphical user interface, or the like.

At block 1010, the first group member device sends the direction indicated by the input as a velocity to the control server 104. For example the velocity may include the direction as well as a magnitude, determined, for example, based on a length of the key press, or similar. In other examples, the magnitude of the velocity may be set to a default magnitude. As will be appreciated, the velocity may be accompanied by the first group member participant identifier to allow the control server 104 to process the velocity.

At block 1015, the control server 104 receives the velocity and proceeds to block 1020 to process the velocity. In some examples, when the control server 104 receives a velocity from multiple group member devices simultaneously, the control server 104 may resolve conflicts in the received velocities. For example, if two velocities are received and are directly opposing, the two opposing velocities may cancel one another out and result in a velocity of zero. In other examples, the velocities may be combined, by adding the velocity vectors to generate a resulting overall velocity used to update the position of the group.

At block 1020, the control server 104 uses the velocity received at block 1015 to update the position of the first group member device. For example, the velocity may be applied to the scale of the map, and the XY-coordinates of the first group member account may be updated. Additionally, since the first group member participant account is in a group, the other group member participant accounts in the group may also have their position updated in the same manner as the first group member device. That is, movement of any one of the members of the group will cause a change in position of each of the other group members.

At block 1025, the control server 104 propagates the updated positions of each of the group members to the first group member device and the other group member devices, as well as to other participant devices.

At blocks 1030-1 and 1030-2, the first group member device and the other group member devices receive the updated positions of each of the group members. As will be appreciated, the other participant devices may similarly receive the updated positions of each of the group members.

At blocks 1035-1 and 1035-2, the first group member device and the other group member devices update the position markers to reflect the updated positions of the group members on the displayed maps. As will be appreciated, as the group member accounts share a position which are updated together, the weighting of the media streams for group members may remain at full opacity and full volume.

As will be appreciated, having updated a position of a participant account, the updated position may prompt a re-iteration of the method 850 by each of the participant devices, including the inviting device and the invited device, as well as the client device 108 to determine which media streams to display.

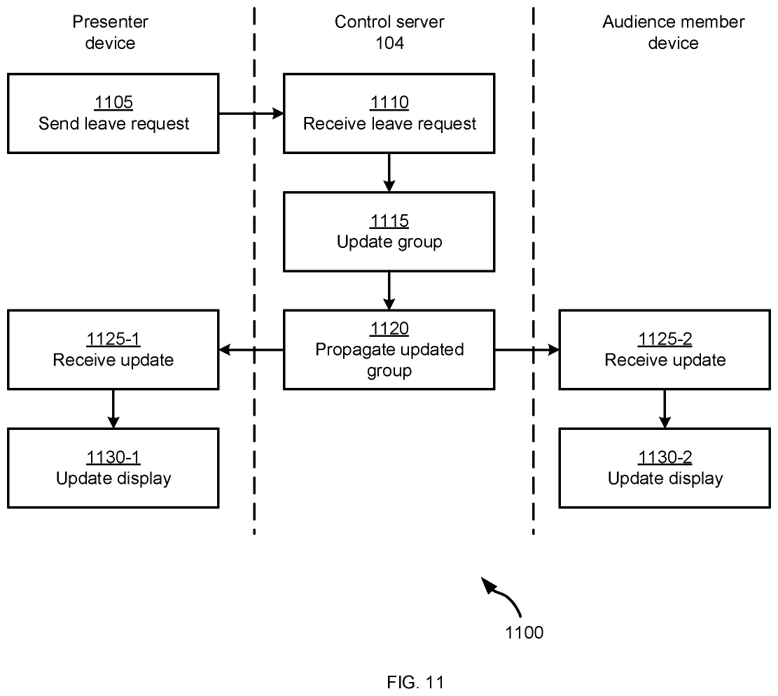

FIG. 11 depicts a flowchart of an example method 1100 of a group member leaving a group. The method 1100 will be described in conjunction with its performance by a leaving device, the control server 104 and the other group member devices. As will be appreciated, any of the group member devices (e.g., the client device 108 or any of the participant devices 112) may be the leaving device.

At block 1105, the leaving device sends a leave request to the control server 104. For example, the leave request may be sent in response to an input at the leaving device provided by a user of the leaving device. For example, when clicking or hovering over a video stream of another group member in the media stream display region, the leaving device may display an overlay for the user to leave the group.

At block 1110, the control server 104 receives the leave request and proceeds to block 1115 to process the leave request.

At block 1115, the control server 104 updates the group. In particular, the control server 104 may first identify the group of which the leaving participant account is part, by searching the session database 216. The control server 104 may then update the group list to remove the leaving participant identifier. When there is a single member of the group remaining after removing the leaving participant identifier, the control server 104 may dissolve the group.

In some examples, in addition to removing the leaving participant account from the group list, the control server 104 may update the position of the leaving participant account to be a default distance away from the position of the other group member accounts to aid in visually signifying the leaving participant account's departure from the group.

At block 1120, the control server 104 propagates the updated group data to the leaving device and the other group member devices. In particular, may send an updated group list to the leaving device and each of the other group member devices, as well as an updated position for the leaving device. As will be appreciated, the control server 104 may similarly propagate the updated position for the leaving device to other participant devices.

At blocks 1125-1 and 1125-2, the leaving device and the other group member devices receive the updated group data to the leaving device and each of the other group member devices. As will be appreciated, the other participant devices may similarly receive the updated position of the leaving device.

At blocks 1130-1 and 1130-2, the leaving device and the other group member devices update the position marker of the leaving device to reflect the updated position of the leaving device on the displayed account.

As will be appreciated, having updated a position of a participant account, the updated position may prompt a re-iteration of the method 850 by each of the participant devices, including the inviting device and the invited device, as well as the client device 108 to determine which media streams to display. For example, the media stream displays may also revert to a distance-based weighting, and hence the weighting of the media streams between the leaving device and the other group member devices may be adjusted to be less than full opacity and full volume, according to the distance between the respective devices.

As described above, the base map 404 may be divided into a plurality of regions 406 which may include one or more small group conferencing regions and one or more large group conferencing regions. The regions 406 may be unmarked on the base map 404, or the regions 406 may be displayed to the user on the base map 404. In some examples, one or more regions 406 may be represented as rooms on the base map 404. To avoid overloading the control server 104, each of the regions 406 may be allocated to one of a plurality of cooperating servers. Each cooperating server may implement the functionality of the control server 104.

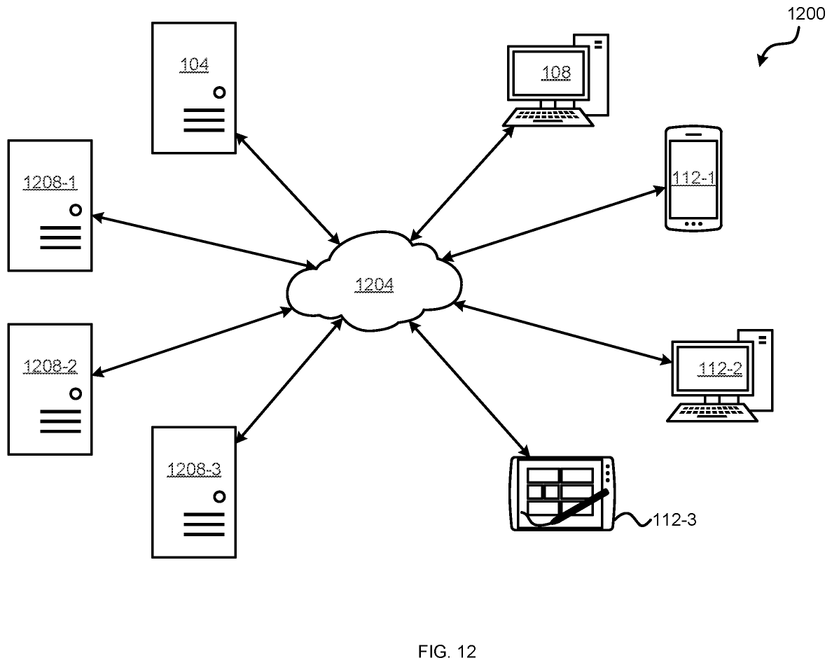

For example, referring to FIG. 12, an example media exchange system 1200 is depicted. In particular, the media exchange system 1200 includes the control server 104 to manage the allocation of media streams to one or more cooperating servers 1208. In some examples, the functionality of the cooperating servers may be implemented on any suitable server environment including a cloud-based server environment, or the like. The control server 104 and the cooperating servers 1208 are in communication with the client device 108 and the participant devices 112 via a network 1204. The network 1204 may comprise a wired or wireless communication link or a combination of wired and wireless communication links. For example, the network 1204 may be provided by a wireless local area network (WLAN) deployed by one or more access points (not shown). In other examples, the network 1204 may include one or more wide-area networks such as the Internet, mobile networks, combinations of the above, and the like.

In operation, the control server 104 receives requests from the client device 108 or the participant devices 112 to join one of the regions 406. In this example, the client device 108 requests to join region 406-1, however the request may be made in respect to any of the plurality of regions 406. In response to such requests, the control server 104 may allocate one of the cooperating servers 1208 to the region 406-1. In this example, the allocated server is cooperating server 1208-1. Once allocated to the region 406-1, the cooperating server 1208-1 receives media streams from participant identifiers that are positioned in the region 406-1 and forwards media streams to the participant devices 112 within the region 406-1. As described above, the cooperating server 1208-1 may be configured to forward a media stream to the participant device 112 if the media stream was obtained from a nearby participant account.

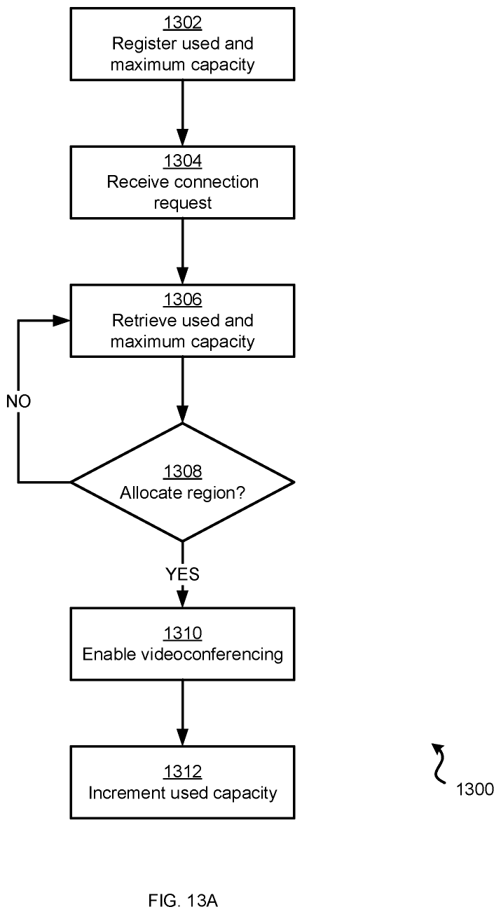

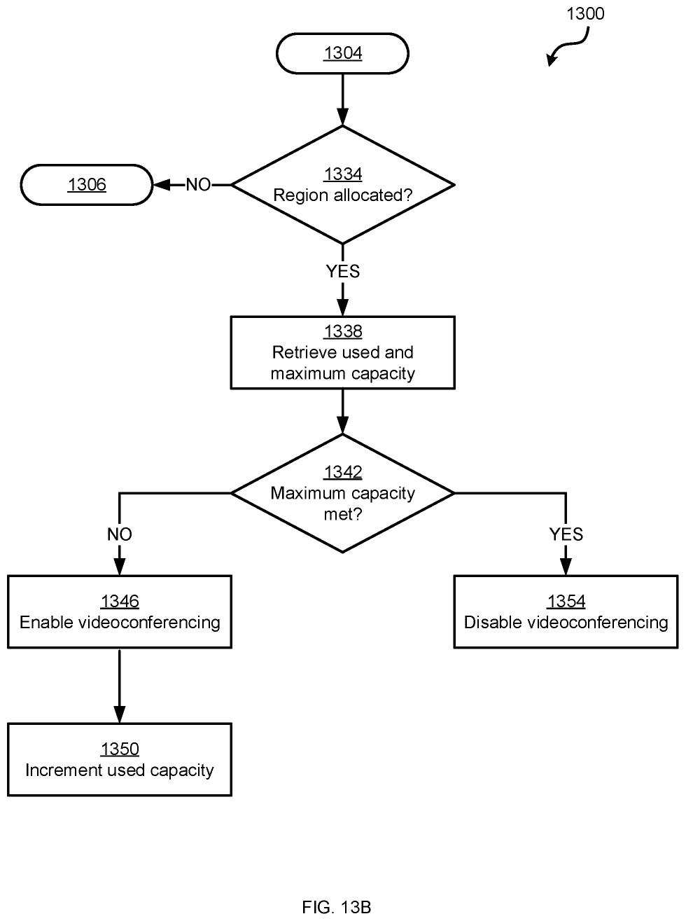

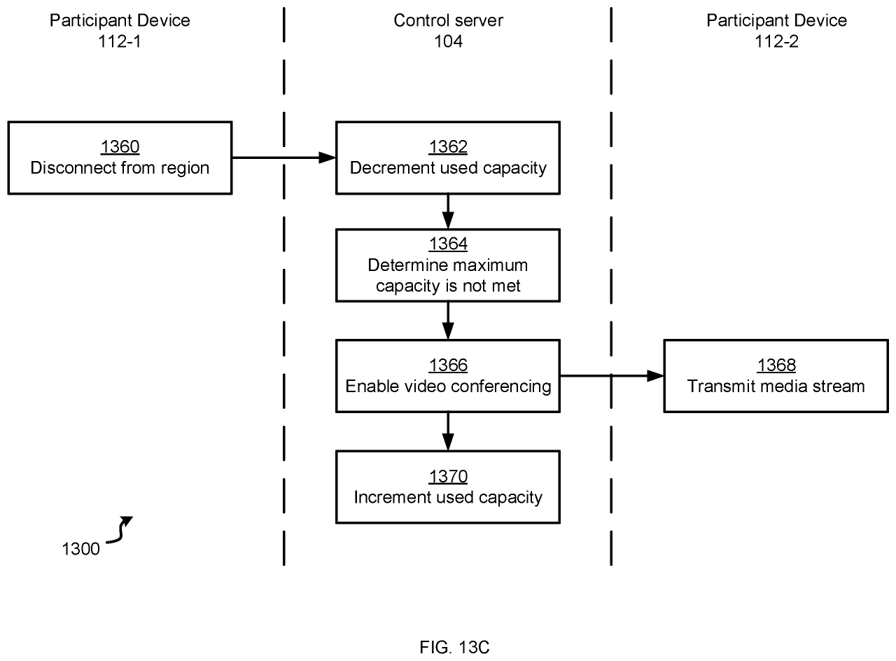

Turning to FIGS. 13A to C, a flowchart of an example method 1300 of allocating servers is depicted. The method 1300 is depicted with respect to the participant device 112 requesting to join one of the regions 406, but the method 1300 may also apply to the client device 108. Some or all of the method 1300 may be implemented by a separate load balancer.

Server allocation is facilitated by the control server 104 registering the used and maximum capacity of the cooperating servers 1208, as depicted at block 1302 in FIG. 13A. The maximum capacity may be determined by one of more of the following limitations: the processing ability of the respective server, the memory of the respective server, the network connection, the bit rate of the media streams, and the like. The maximum capacity of the cooperating server 1208 may be registered in a number of suitable units including a bit rate or a number of devices 108, 112 that can stream video through the cooperating server 1208. The used capacity represents the proportion of the maximum capacity that is being utilized at any given time point. The used capacity of the cooperating server 1208 may be registered in a number of suitable units including a bit rate or a number of devices 108, 112 that are connected to the cooperating server 1208 at any given time point. It may be advantageous for the used capacity and the maximum capacity to be registered in the same unit of measurement. As part of block 1302, the used and maximum capacity of the cooperating server 1208 are stored in memory at the respective cooperating server, or in memory at the control server 104. In some implementations, the used and maximum capacity may be stored in a database at the control server 104. Block 1302 may be performed once, periodically, or as requested.

At block 1304, when the user requests to join a region 406, the control server 104 receives a connection request from the participant device 112 to join the region 406. In the example described herein, the participant device 112-1 is requesting to join region 406-1. The connection request may be transmitted by the participant device 112-1 to the control server 104 in response to the participant device 112-1 connecting to the videoconferencing session or in response to the user navigating from one region 406 to another region 406 within the map area. In examples where the regions are displayed as rooms on the map, the user may navigate into the room through a door, and the connection request may be transmitted in response to the user navigating through a door. The connection request includes the participant identifier for an endpoint participant account whose participant identifier is located within the requested region 406-1. In the example shown in FIG. 13A, the region 406-1 is unallocated because there are no participant identifiers located in the region 406-1.

At block 1306, the control server 104 retrieves the used and maximum capacity of one or more of the cooperating servers 1208. At block 1308, the control server 104 determines whether or not to allocate the region 406-1 to a first cooperating server 1208-1 based on a comparison between the used and maximum capacity for the respective cooperating server. In some examples, if the used capacity is less than the maximum capacity, the control server 104 allocates region 406-1 to the cooperating server 1208-1. In other examples, the control server 104 only allocates region 406-1 to the cooperating server 1208-1 if the difference between the used capacity and the maximum capacity meets a predetermined threshold. The predetermined threshold may reflect the processing power required in order for one or more participant devices 112 to participate in videoconferencing. If the control server 104 determines not to allocate the region 406-1 to said cooperating server 1208-1, the control server 104 returns to block 1306 and retrieves the used and maximum capacity for a second cooperating server 1208-2. The control server 104 repeats block 1306 and 1308 until region 406-1 is allocated to one of the cooperating servers 1208. If none of the cooperating servers 1208 have sufficient capacity for region 406-1, the control server 104 may repeat blocks 1306 and 1308 for all of the cooperating servers 1208. In some examples, the control server 104 may transmit an error message if none of the cooperating servers 1208 have sufficient capacity for region 406-1. The error message may be transmitted to one or more of the client devices 108 and the participating devices 112.

Instead of evaluating each of the cooperating servers 1208 in sequence, as shown in FIG. 13A, the control server 104 may perform block 1306 for a plurality of the cooperating servers 1208 before proceeding to block 1308. A block 1308, the control server 104 may then select one of the cooperating servers 1208 to allocate region 406-1 based on the retrieved capacities.

As part of block 1308, the control server 104 may also generate a record indicating the allocated region 406-1 and the cooperating server 1208-1 to which the region 406-1 is allocated. The record may be stored in memory at the control server 104 or the cooperating server 1208.

After the control server 104 allocates region 406-1 to the cooperating server 1208-1, the control server 104 enables videoconferencing for the participating device 112-1, as depicted at block 1310. As a result, the participating device 112-1 is enabled to exchange media streams with the cooperating server 1208-1 via the network 1204. In particular, the cooperating server 1208-1 may transmit to the participating device 112-1 one or more media streams obtained from nearby users. Similarly, the cooperating server 1208-1 may transmit to nearby users the media stream obtained from the participating device 112-1. In some examples, the nearby users are limited to users in the same region.

At block 1312, the control server 104 increments the used capacity for the respective cooperating server 1208-1. The updated value for the used capacity may be stored in memory at the respective cooperating server 1208-1 or at the control server 104.

In circumstances where the region 406 has already been allocated to one of the cooperating servers 1208, it may not be necessary to repeat steps 1306 to 1308. As shown in FIG. 13B, the control server 104 receives a connection request, which includes the participant identifiers that are located in the region 406-1. Upon receiving the connection request at block 1304, the control server 104 may first determine whether or not the region 406-1 has been allocated to one of the cooperating servers 1208. This step, indicated at block 1334 in FIG. 13B, may be performed by querying one or more records stored in memory at the control server 104 or the cooperating server 1208d. If the region 406-1 has not yet been allocated to a server, the control server 104 proceeds to block 1306 as described above. If the region 406-1 has already been allocated to the cooperating server 1208-1, the control server 104 proceeds to block 1338.

At block 1338, the control server 104 retrieves the used and maximum capacity for the cooperating server 1208-1 to which region 406-1 has been allocated.

At block 1342, the control server 104 determines whether or not the maximum capacity for the cooperating server 1208-1 has been met. In some examples, if the used capacity is less than the maximum capacity, the control server 104 proceeds to block 1346, and if the used capacity is equal to the maximum capacity, the control server 104 proceeds to block 1354. In other examples, the control server 104 only proceeds to block 1346 if the difference between the used capacity and the maximum capacity meets a predetermined threshold. The predetermined threshold may reflect the processing power required in order for the participant device 112-1 to participate in videoconferencing.

If the capacity is sufficient, the control server 104 enables videoconferencing for the participating device 112-1, as depicted at block 1346. As a result, the participating device 112-1 receives an incoming media stream corresponding to the participant identifier from the connection request at block 1304. In particular, the incoming media stream may include a video stream and an audio stream, as available. The participant device 112-1 may additionally provide an outgoing media stream to the control server 104. In particular, the outgoing media stream may include a video stream and an audio stream captured by the input devices at the participant device 112-1. The participant device 112 may additionally provide the participant identifier associated with the participant account to be associated with the outgoing media stream for identification purposes.

At block 1350, the control server 104 increments the used capacity for the respective cooperating server 1208-1. The updated value for the used capacity may be stored in memory at the respective cooperating server 1208-1 or at the control server 104.

If the capacity is insufficient based on the determination at block 1342, the control server 104 disables videoconferencing for the participating device 112-1, as depicted at block 1354. As a result, the participating device 112-1 may continue to receive participant data, including participant identifiers and position data, however the participating device 112-1 does not exchange media streams with the cooperating server 1208. With videoconferencing disabled, the user may navigate the map area but cannot participate in videoconferencing until the user navigates to a room 406 with capacity or until another user leaves the region.

Turning to FIG. 13C, exemplary performance of the system 1200 is depicted when the participant device 112-1 leaves one of the regions 406. At block 1360, the participant device 112-1 disconnects from the region 406. Disconnecting from the region 406-1 may occur when the participant device 112-1 navigates from a first region 406-1 to a second region 406-2. In some examples, the participant device 112-1 device exits the region 406 by disconnecting from the videoconferencing session altogether. In either case, the control server 108 detects that the participant device 112 has disconnected from the region 406. In some examples, the participant device 112-1 transmits a signal to the control server 104 indicating that the participant device 112-1 has disconnected from the region 406. Upon receiving said signal, the control server 104 responds by decrementing the used capacity for the cooperating server 1208-1 associated with the region 406-1, as shown at block 1364. The updated value for the used capacity may be stored in memory at the respective cooperating server 1208-1 or at the control server 104.

After decrementing the used capacity, the control server 104 determines whether or not the capacity for the cooperating server 1208-1 is sufficient to admit an additional user. As part of block 1364, the control server 104 may determine that the difference between the maximum capacity and the used capacity for the cooperating server 1208-1 exceeds a predetermined threshold.

As part of block 1364, the control server 104 may further compute the number of participant identifiers that remain in the region R-1 after the participant device 112-1 has disconnected from the region R-1. If the number of participating identifiers is zero, the control server 104 may remove the region R-1 from allocation at the cooperating server 1208. This may make the cooperating server 1208 available to host other regions if requested by the participants. If the control server 104 determines that no participants remain in the region R-1, the method 1300 may stop at block 1364. If the control server 104 determines that at least one participant remains in the region R-1, the method 1300 proceeds to 1366.

At block 1366, the control server 104 enables video conferencing for one or more users located in the region. As part of block 1366, the control server 104 determines that at least one user in the region 406-1 is not exchanging media streams with the cooperating server 1208-1. Consequently, the control server 104 enables video conferencing for one or more of the users, depending on the difference between the used and maximum capacities as calculated at block 1364. If the difference between the used and maximum capacities is insufficient to allow all of the users to enable video conferencing, the control server 104 may enable select one or more users to enable video conferencing. The control server 104 may employ a number of methods to prioritize which users should enable video conferencing first. In some instances, the order of priority may reflect the order in which the users joined the region.

In the example shown, the participant device 112-2 has been waiting in the region 406-1 and at block 1366, the control server 104 enables participant device 112-2 to join the video conference. As a result, the participating device 112-2 receives an incoming media stream corresponding to the participant identifier from the connection request at block 1304. In particular, the incoming media stream may include a video stream and an audio stream, as available. The participant device 112-2 may additionally provide an outgoing media stream to the control server 104. In particular, the outgoing media stream may include a video stream and an audio stream captured by the input devices at the participant device 112-2. The participant device 112-2 may additionally provide the participant identifier associated with the participant account to be associated with the outgoing media stream for identification purposes.

At block 1370, the control server increments the used capacity for the cooperating server 1208. The updated value for the used capacity may be stored in memory at the respective cooperating server 1208-1 or at the control server 104.

As described above, a video conferencing system may provide a continuous navigable map for participants to traverse. The continuous nature of the map allows for distance-based weighting of media streams to mimic in-person effects of moving towards and away from participants in conversation. Additionally, the distance basis allows for a threshold distance and nearest neighbors to be selected to provide a small class with whom to exchange media streams for a more intimate experience. The system may further support grouping so that a group of participants may be linked in their navigation and their exchange of media streams. In other modes, the system further supports broadcasting (from a presenter to an audience) and large group conferencing.

The scope of the claims should not be limited by the embodiments set forth in the above examples but should be given the broadest interpretation consistent with the description as a whole.

1. A method of video conferencing, the method comprising:
receiving, from a control server, an initiation package for a client account associated with a client device, the initiation package including a client participant identifier defining the client account within a video conferencing session, a base map, and a position of the client account on the base map;
displaying, at the client device, the base map and a position marker on the base map, the position marker representing the position of the client account on the base map;
obtaining a set of nearby participant identifiers representing nearby participant accounts selected based on a proximity of respective positions of the nearby participant accounts to the position of the client account;
obtaining, based on the set of nearby participant identifiers, a set of media streams for the nearby participant accounts; and
outputting the set of media streams at the client device.

2. The method of claim 1, wherein obtaining the set of media streams comprises:
sending, for each participant identifier in the set of nearby participant identifiers, a subscription request to a selective forwarding unit server, the subscription request for a respective media stream associated with the participant identifier; and
receiving, from the selective forwarding unit server, the respective media stream.

3. The method of claim 1, wherein obtaining the set of media streams comprises:
establishing, for each participant identifier in the set of nearby participant identifiers, a peer-to-peer communication link with a participant device associated with the participant identifier; and
receiving, from the participant device, a respective media stream over the peer-to-peer communication link.

4. The method of claim 1, further comprising providing, to each participant device associated with the set of nearby participant identifiers, an outgoing media stream.

5. The method of claim 1, wherein the set of nearby participant identifiers is selected based on a k-nearest neighbors classification with a threshold number of nearby participant accounts.

6. The method of claim 5, wherein the set of nearby participant identifiers is further selected such that each nearby participant identifier corresponds to a nearby participant account having a respective position within a threshold distance of the position of the client account.

7. The method of claim 1, further comprising, for each participant account corresponding to a nearby participant identifier in the set:
adjusting an opacity of a video stream portion of the media stream based on a distance between a respective position of the participant account and the position of the client account; and
adjusting a volume of an audio stream portion of the media stream based on the distance between the respective position of the participant account and the position of the client account.

8. The method of claim 1, further comprising:
in response to an input, sending, to the control server, a velocity corresponding to the input;
receiving, from the control server, an updated position for the client account; and
updating, the position marker to represent the updated position of the client account on the base map.

9. The method of claim 1, further comprising:
receiving, from the control server, a set of presenter participant identifiers;
obtaining a set of broadcasted media streams for each presenter participant account associated with a presenter participant identifier in the set of presenter participant identifiers; and
outputting the set of broadcasted media streams.

10. The method of claim 1, further comprising:
receiving an input at the client device, the input indicative of a direction of movement;
sending a velocity to the control server based on the direction of movement;
receiving an updated position for the client account; and
updating, at the client device, the position marker to reflect the updated position of the client account on the base map.

11. The method of claim 10, further comprising:
obtaining an updated set of nearby participant identifiers representing nearby participant accounts selected based on proximity of the respective positions of the nearby participant accounts to the updated position of the client account;
obtaining, based on the updated set of nearby participant identifiers, an updated set of media streams for the nearby participant accounts; and
outputting the updated set of media streams at the client device.

12. The method of claim 1, further comprising:
sending a group request to the control server, the group request including an invited participant identifier associated with an invited participant account;
receiving, from the control server, a group list including the client participant identifier and the invited participant identifier and an updated position of the invited participant account; and
updating an invited position marker representing the updated position of the invited participant account.

13. The method of claim 1, further comprising:
receiving, from the control server, an invitation to join a group;
in response to an input at the client device, sending an acceptance of the invitation to the control server;
receiving, from the control server, a group list including the client participant identifier and an inviting participant identifier and an updated position of the client account; and
updating the position marker to reflect the updated position of the client account.

14. The method of claim 1, further comprising:
joining a group including the client account and one or more group member accounts;
receiving an updated position for the client account and updated group member positions for each of the one or more group member accounts; and
updating, at the client device, the position marker to reflect the updated position of the client account on the base map and group member position markers to reflect the updated group member positions of each of the group member accounts.

15. The method of claim 14, further comprising:
receiving an input at the client device, the input indicative of a direction of movement; and
sending a velocity to the control server based on the direction of movement to cause the updated position and the updated group member positions.

16. The method of claim 1, wherein the base map includes a region, the method further comprising:
receiving a connection request from the client device, the connection request comprising a request to connect to the region;
retrieving, at the control server, a used capacity and a maximum capacity for a cooperating server;
if the used capacity is less than the maximum capacity, allocating the region to the cooperating server;
obtaining, at the cooperating server, a subset of media streams corresponding to a subset of participant accounts, the subset of participant accounts corresponding to the participant accounts positioned in the region; and
outputting, at the client device, the subset of media streams.

17. The method of claim 16, wherein the client identifier is positioned within said region, the method of claim 16 further comprising incrementing, at the control server, the used capacity in response to the connection request.

18. The method of claim 16, further comprising:
receiving, at the control server, a second connection request from a participant device, the second connection request comprising a request to connect to the region;
determining, at the control server, whether or not the used capacity is less than the maximum capacity;
if the used capacity is less than the maximum capacity, outputting, at the participant device, the subset of media streams;
if the used capacity is not less than the maximum capacity, disabling videoconferencing for the participant device.
